(19) United States
(12) Patent Application Publication
(10) Pub. No.: US 2025/0184104 A1
(43) Pub. Date: Jun. 5, 2025

(54) SYSTEMS, METHODS, AND DEVICES FOR RESOURCE ALLOCATION FOR SBFD OPERATIONS

(71) Applicant: Apple Inc., Cupertino, CA (US)

(72) Inventors: Seyed Ali Akbar FAKOORIAN, San Diego, CA (US); Haitong SUN, Saratoga, CA (US); Dawei ZHANG, Saratoga, CA (US); Sigen YE, San Diego, CA (US); Dan WU, Beijing (CN); Chunhai YAO, Beijing (CN); Wei ZENG, Saratoga, CA (US)

(21) Appl. No.: 18/963,337

(22) Filed: Nov. 27, 2024

Related U.S. Application Data
(60) Provisional application No. 63/604,741, filed on Nov. 30, 2023.

(51) Int. Cl. H04L 5/14; H04L 5/00; H04W 72/21; H04W 72/232

(52) U.S. Cl. CPC H04L 5/14; H04L 5/0048; H04W 72/21; H04W 72/232

(57) ABSTRACT

The techniques described herein may include solutions for enabling a user equipment (UE) to switch between sub-band full duplex (SBFD) communications and non-SBFD communications within the same time domain of a resource allocation. Discussed herein include solutions for sounding reference signals (SRS), physical uplink (UL) shared channels (PUSCH), and type 1 and type 2 configured grants (CG). Radio resource control (RRC) information, downlink (DL) control information (DCI), layer 1 (L1) indicators, and other types of control information may be used.

### CROSS-REFERENCES TO RELATED APPLICATIONS

This application claims the benefit of U.S. Provisional Application No. 63/604,741, filed Nov. 30, 2023, the entire disclosure of which is herein incorporated by reference for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices to allocate wireless resources for wireless communications between the devices.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of a resource allocation of a time division duplex (TDD) slot and resources of a sub-band full duplex (SBFD) slot.

FIG. 2 is a diagram of an example of an overview for resource allocation for a SBFD and non-SBFD according to one or more implementations described herein.

FIG. 3 is a diagram of an example network according to one or more implementations described herein.

FIG. 4 is a diagram of an example of a process for resource allocation for SBFD according to one or more implementations described herein.

FIG. 5 is a diagram of an information element (IE) and/or parameters for resource allocation for SBFD according to one or more implementations described herein.

FIG. 6 is a diagram of an example of resources of non-SBFD slots and an SBFD slot according to one or more implementations described herein.

FIG. 7 is a diagram of an example of resources of non-SBFD slots and an SBFD slot according to one or more implementations described herein.

FIG. 8 is a diagram of an example of resources of non-SBFD slots and an SBFD slot according to one or more implementations described herein.

FIG. 9 is a diagram of an example process for SBFD resource allocation from the perspective of a user equipment (UE) according to one or more implementations described herein.

FIG. 10 is a diagram of an example process for SBFD resource allocation from the perspective of a base station according to one or more implementations described herein.

FIG. 11 is a diagram of an example of components of a device according to one or more implementations described herein.

FIG. 12 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include allocating wireless resources for uplink (UL) communications and downlink (DL) communications in reliable, efficient, and effective ways.

Wireless resources may be structured and organized according to frames, subframes, slots, symbols, and so on. A frame may have a duration of 10 milliseconds (ms) and may have 10 subframes, each of which has a duration of 1 ms. Each subframe may have 2 slots, and each slot may consist of 14 orthogonal frequency-division multiplexing (OFDM) symbols. Per time division duplexing, frames may be transmitted continuously, and each subframe may be of a fixed duration (i.e., 1 ms); however, slot length may vary based on subcarrier spacing and the number of slots per subframe. For example, a subcarrier spacing of 15 kilohertz (KHz) may result in only 1 slot per subframe, a subcarrier spacing of 30 KHz may result in 2 slots per subframe, and so on. Each slot occupies either 14 OFDM symbols or 12 OFDM symbols based on normal cyclic prefix (CP) and extended CP respectively.

A physical resource block (PRB) may be a fundamental unit of radio resource allocation in wireless communication systems. A PRB may consist of a group of contiguous subcarriers in the frequency domain and a set of consecutive time slots in the time domain. The number of subcarriers and time slots of a PRB may vary depending on the specific deployment scenario and configuration. The data transmitted over PRBs may be organized into transport blocks, which may be encapsulated into radio frames for transmission over the air interface. The size of the transport blocks may determine the amount of data that can be transmitted in each PRB. The modulation and coding scheme (MCS) used for encoding the data also influence the achievable data rate and reliability in a PRB.

A resource element (RE) may be the smallest unit of the resource grid. An RE may consist of one subcarrier in the frequency domain and one OFDM symbol in time domain. A resource block (RB) is defined only for a frequency domain as 12 (N_RB_sc) consecutive subcarriers in the frequency domain. Time domain definition of a resource block is a minimum time domain length in a resource block can be one OFDM symbol, but the exact time domain length may vary depending on a start length indicator value (SLIV), which may indicate a start and a length the time domain allocation of a PDSCH.

A resource grid may correspond to one antenna port and a numerology. A resource grind may include an arrangement of REs, RB, subframes, and subcarriers. A resource grid may correspond to one antenna port and a numerology. There may be one set of resource grids per transmission direction (uplink or downlink) with the subscript set to DL and UL. Thus, there may be one resource grid for a given antenna port p, subcarrier spacing configuration u, and transmission direction (DL or UL). The physical dimensions (e.g., subcarrier spacing (SCS), number of OFDM symbols within a radio frame, etc.) may vary depending on numerology (duration, periodicity, etc.).

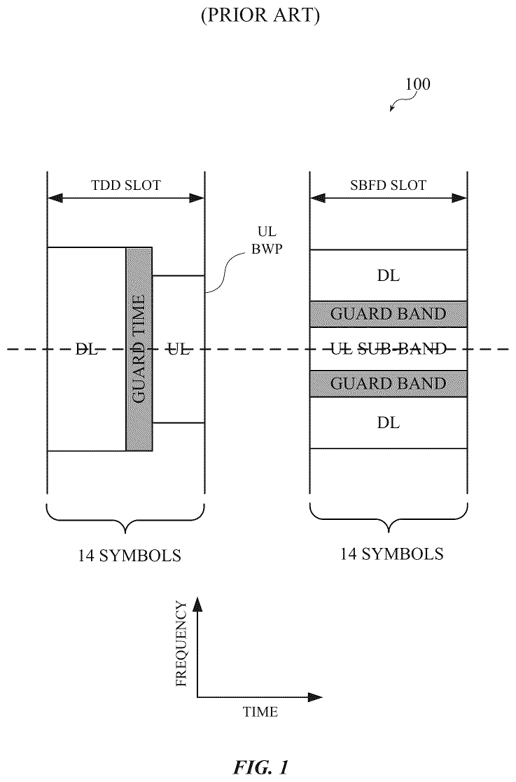

FIG. 1 is a diagram of an example 100 of a time division duplex (TDD) slot and a sub-band full duplex (SBFD) slot. As shown, the TDD slot may include a timing guard separating DL communications and UL communications that use overlapping bands. The timing guard may help ensure that reused frequencies for the DL and UL communications do not interfere with one another. Additionally, the frequency band for DL communications may be larger than the frequency band for UL communications. The frequency band for UL communications may include, or be referred to as, a bandwidth part (BWP). Thus, TDD may include a communication scheme where DL and UL transmissions are performed at different times but use the same or similar frequencies.

Full duplex (FD) communications may include a scenario in which DL and UL communications are performed at the same (or overlapping) times. SBFD may include FD communications while separating DL and UL communications into different frequency bands, which may be referred to as sub-bands. As such, the depicted SBFD slot may include sub-bands for DL and UL communications that overlap in time but are separated by guard bands. The guard bands may help ensure that frequencies from one transmission do not interfere with those of another. Thus, while TDD slot and SBFD slot may be the same or similar in terms of time and frequency resources, each has different characteristics because of how those resources are arranged. For example, the UL band of the TDD slot may have more bandwidth for a shorter period of time relative to the smaller bandwidth for a greater period of time of the SBFD slot.

Currently available technologies fail to provide any, or adequate, solutions for enabling UEs and base stations to communicate via SBFD and non-SBFD (e.g., TDD) communication schemes. For example, currently available technologies fail to provide solutions for enabling UEs to transition between non-SBFD communications and SBFD communications. This may be due, at least in part, to the different allocations of resources between the different communication schemes. For example, the UL resources allocated TDD slots may be suitable for a sounding reference signals (SRS), physical uplink shared channel (PUSCH), etc., but the UL resources allocated SBFD slots may be inadequate. The scheduling, periodicity, etc., of these communications may also be problematic since different UL communications may repeat or recur at different rates. As such, currently available technologies fail to provide adequate solutions to enable UEs and base stations to switch between SBFD and non-SBFD communication schemes.

The techniques described herein address the deficiencies of the currently available technologies by providing solutions for enabling UEs and base stations to switch between SBFD and non-SBFD communication. Examples of such communications may include SRS (including periodic SRS (P-SRS), semi-persistent SRS (SP-SRS), and aperiodic SRS (AP-SRS). Additional examples may include those involving a PUSCH in a type 0 or type 1 frequency domain resource assignment (FDRA) scenarios, a PUSCH in a configured grant (CG) scenario, and a PUSCH and/or PDSCH in a multi-grant scenario.

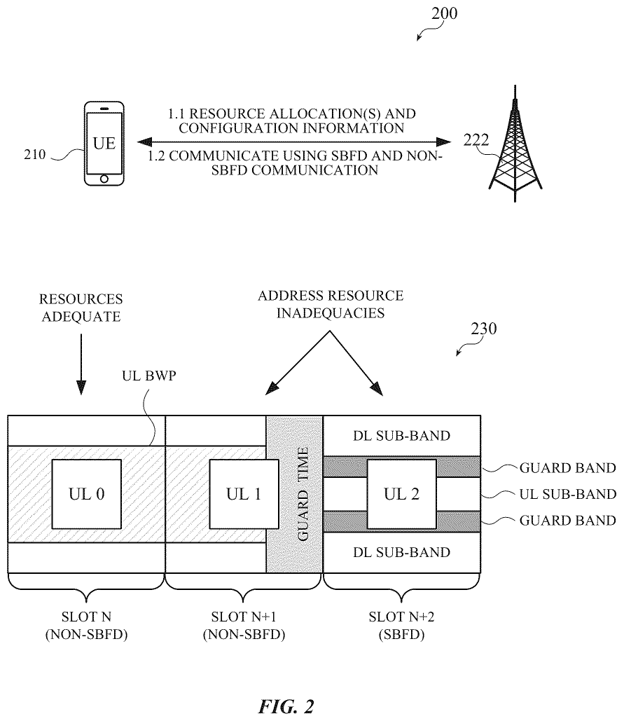

FIG. 2 is a diagram of an example of an overview 200 of resource allocation for SBFD according to one or more implementations described herein. As shown, overview 200 may include UE 210, base station 222, and a series of slots 230 (e.g., slot N, slot N+1, and slot N+2). Slot N and N+1 may be non-SBFD slots; slot N+2 may be an SBFD slot. Base station 222 may communicate resource allocation and configuration information to UE 210. The resource allocation may include time and frequency resources, channels, carriers, bands, etc., that UE 210 may use to communicate with base station 222. The configuration information may include information to configure and/or enable UE 210 to switch between SBFD and non-SBFD schemes while using the allocated resources. The configuration information may include layer 1 (L1) information, downlink control information (DCI), radio resource control (RRC), transmission control indicators (TCI), etc.

UE 210 may also have scheduled UL communications (e.g., UL 0, UL 1, and UL 2. These may refer to SRS transmissions, PUSCH transmissions, configured grant (CG) transmissions, and more. UE 210 may transmit UL 0 since UL 0 complies with the UL resources allocated to UE 210 (e.g., within the period of time and frequency range (e.g., BWP)) allocated to non-SBFD slot N. By contrast, the resource allocations for non-SBFD slot N+1 and SBFD slot N+2 may be inadequate for UL 1 and UL 2, respectively. As such, UE 210 may implement one or more strategies to address the inadequacies of non-SBFD slot N+1 and SBFD slot N+2 relative to UL 1 and/or UL 2. UE 210 may do so based on the configuration information received from base station 222. In some implementations, this may include not transmitting UL 1 and/or UL 2, adjusting a guard time of SLOT N+1, adjusting one or more guard bands of SLOT N+2, adjusting the UL sub-band of SLOT N+2, adjusting the time and/or frequency requirements of UL 2, or one or more other techniques. Accordingly, the techniques described herein may wireless devices to communicate despite transitioning between SBFD and non-SBFD symbols and slots. These and many other features and examples are described in additional detail with reference to remaining Figures.

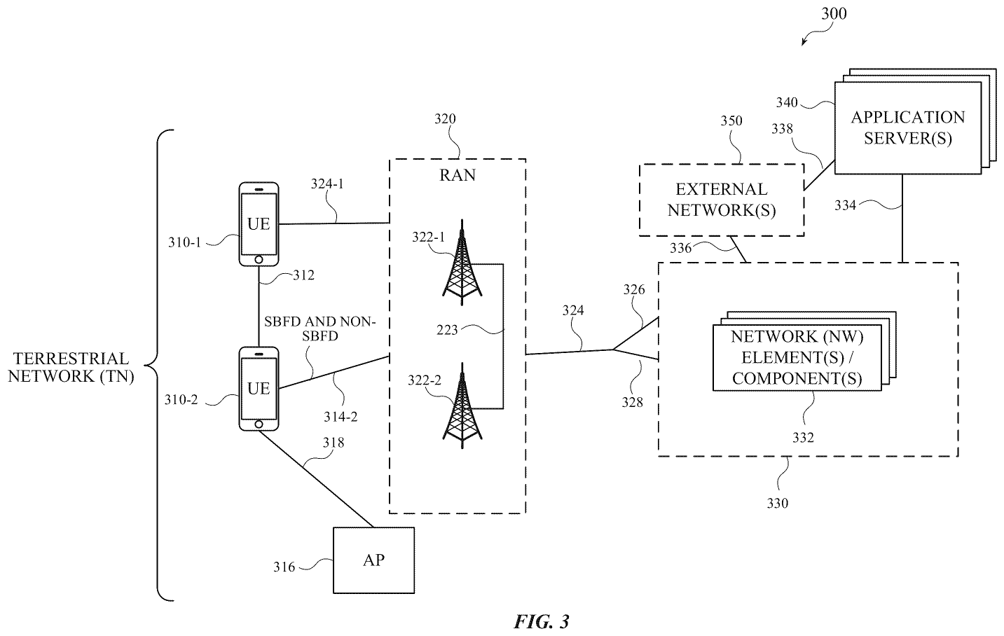

FIG. 3 is an example network 300 according to one or more implementations described herein. Example network 300 may include UEs 310-1, 310-2, etc. (referred to collectively as “UEs 310” and individually as “UE 310”), a radio access network (RAN) 320, a core network (CN) 330, application servers 340, and external networks 350.

The systems and devices of example network 300 may operate in accordance with one or more communication standards, such as 3rd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 300 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 310 may include smartphones (e.g., handheld touchscreen mobile computing devices connectable to one or more wireless communication networks). Additionally, or alternatively, UEs 310 may include other types of mobile or non-mobile computing devices capable of wireless communications, such as personal data assistants (PDAs), pagers, laptop computers, desktop computers, wireless handsets, etc. In some implementations, UEs 310 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSc) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network. UEs 310 can communicate and establish a connection with one or more other UEs 310 via one or more wireless channels 312, each of which can comprise a physical communications interface/layer.

UEs 310 may communicate and establish a connection with (e.g., be communicatively coupled) with RAN 320, which may involve one or more wireless channels 314-1 and 314-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 322-1 and 322-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 330. Additionally, at least one of the MN or the SN may be operated with shared spectrum channel access, and functions specified for UE 310 can be used for an integrated access and backhaul mobile termination (IAB-MT). Similar for UE 310, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 320.

As described herein, UE 310 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 310 may also, or alternatively, connect to access point (AP) 316 via connection interface 318, which may include an air interface enabling UE 310 to communicatively couple with AP 316. AP 316 may comprise a wireless local area network (WLAN), WLAN node, WLAN termination point, etc. The connection 318 may comprise a local wireless connection, such as a connection consistent with any IEEE 702.11 protocol, and AP 316 may comprise a wireless fidelity (Wi-Fi®) router or other AP. While not explicitly depicted in FIG. 3, AP 316 may be connected to another network (e.g., the Internet) without connecting to RAN 320 or CN 330. In some scenarios, UE 310, RAN 320, and AP 316 may be configured to utilize LTE-WLAN aggregation (LWA) techniques or LTE WLAN radio level integration with IPsec tunnel (LWIP) techniques. LWA may involve UE 310 in RRC_CONNECTED being configured by RAN 320 to utilize radio resources of LTE and WLAN. LWIP may involve UE 310 using WLAN radio resources (e.g., connection interface 318) via IPsec protocol tunneling to authenticate and encrypt packets (e.g., Internet Protocol (IP) packets) communicated via connection interface 318. IPsec tunneling may include encapsulating the entirety of original IP packets and adding a new packet header, thereby protecting the original header of the IP packets.

RAN 320 may include one or more RAN nodes 322-1 and 322-2 (referred to collectively as RAN nodes 320, and individually as RAN node 320) that enable channels 314-1 and 314-2 to be established between UEs 310 and RAN 320. RAN nodes 320 may include network access points configured to provide radio baseband functions for data and/or voice connectivity between users and the network based on one or more of the communication technologies described herein (e.g., 3G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 320 may include a roadside unit (RSU), a transmission reception point (TRxP or TRP), and one or more other types of ground stations (e.g., terrestrial access points). In some scenarios, RAN node 320 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 320, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 320; a media access control (MAC)/physical (PHY) layer split wherein RRC, PDCP, radio link control (RLC), and MAC layers may be operated by the CRAN/vBBUP and the PHY layer may be operated by individual RAN nodes 320; or a “lower PHY” split wherein RRC, PDCP, RLC, MAC layers and upper portions of the PHY layer may be operated by the CRAN/vBBUP and lower portions of the PHY layer may be operated by individual RAN nodes 320. This virtualized framework may allow freed-up processor cores of RAN nodes 320 to perform or execute other virtualized applications.

In some implementations, an individual RAN node 320 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 320 or by a server pool (e.g., a group of servers configured to share resources) in a similar manner as the CRAN/vBBUP. Additionally, or alternatively, one or more of RAN nodes 320 may be next generation eNBs (i.e., gNBs) that may provide evolved universal terrestrial radio access (E-UTRA) user plane and control plane protocol terminations toward UEs 310, and that may be connected to a 5G core network (5GC) 330 via an NG interface.

Any of the RAN nodes 320 may terminate an air interface protocol and may be the first point of contact for UEs 310. In some implementations, any of the RAN nodes 320 may fulfill various logical functions for the RAN 320 including, but not limited to, radio network controller (RNC) functions such as radio bearer management, uplink and downlink dynamic radio resource management and data packet scheduling, and mobility management. UEs 310 may be configured to communicate using orthogonal frequency-division multiplexing (OFDM) communication signals with each other or with any of the RAN nodes 320 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 320 to UEs 310, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 320 may be configured to wirelessly communicate with UEs 310, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 310 and the RAN nodes 320 may operate using stand-alone unlicensed operation, licensed assisted access (LAA), eLAA, and/or feLAA mechanisms. In these implementations, UEs 310 and the RAN nodes 320 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 310. The physical downlink control channel (PDCCH) may carry information about the transport format and resource allocations related to the PDSCH channel, among other things. The PDCCH may also inform UEs 310 about the transport format, resource allocation, and hybrid automatic repeat request (HARQ) information related to the uplink shared channel. Typically, downlink scheduling (e.g., assigning control and shared channel resource blocks to UE 310 within a cell) may be performed at any of the RAN nodes 320 based on channel quality information fed back from any of UEs 310. The downlink resource assignment information may be sent on the PDCCH used for (e.g., assigned to) each of UEs 310.

One or more of the techniques, described herein, SBFD operations. This may include causing or enabling UE 310 to switch between SBFD communications and non-SBFD communications within the same time domain of a resource allocation. SRS, PUSCH, and type 1 and type 2 CG scenarios may be involved. Also included may be the transmission and/or reception of RRC information, DCI, L1 indicators, and/or one or more other types of control information. Details and examples of such techniques are described below with reference to the Figures that follow.

The RAN nodes 320 may be configured to communicate with one another via interface 223. In implementations where the system is an LTE system, interface 223 may be an X2 interface. In NR systems, interface 223 may be an Xn interface. The X2 interface may be defined between two or more RAN nodes 320 (e.g., two or more eNBs/gNBs or a combination thereof) that connect to evolved packet core (EPC) or CN 330, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 310 from an SeNB for user data; information of PDCP PDUs that were not delivered to a UE 310; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 320 may be connected (e.g., communicatively coupled) to CN 330 via interfaces 324, 336, and 328. CN 330 may comprise a plurality of network elements 332, which are configured to offer various data and telecommunications services to customers/subscribers (e.g., users of UEs 310) who are connected to the CN 330 via the RAN 320. In some implementations, CN 330 may include an evolved packet core (EPC), a 5G CN, and/or one or more additional or alternative types of CNs. The components of the CN 330 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 330 may be referred to as a network slice, and a logical instantiation of a portion of the CN 330 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 330, application servers 340, and external networks 350 may be connected to one another via interfaces 334, 336, and 338, which may include IP network interfaces. Application servers 340 may include one or more server devices or network elements (e.g., virtual network functions (VNFs) offering applications that use IP bearer resources with CN 330 (e.g., universal mobile telecommunications system packet services (UMTS PS) domain, LTE PS data services, etc.). Application servers 340 may also, or alternatively, be configured to support one or more communication services (e.g., voice over IP (VOIP sessions, push-to-talk (PTT) sessions, group communication sessions, social networking services, etc.) for UEs 310 via the CN 330. Similarly, external networks 350 may include one or more of a variety of networks, including the Internet, thereby providing the mobile communication network and UEs 310 of the network access to a variety of additional services, information, interconnectivity, and other network features.

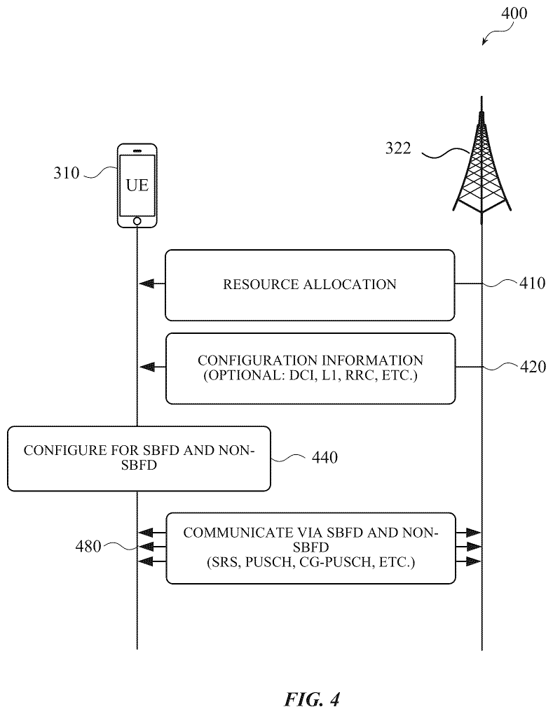

FIG. 4 is a diagram of an example of a process 400 for resource allocation for SBFD according to one or more implementations described herein. Process 400 may be implemented by UE 310 and base station 322. In some implementations, some or all of process 400 may be performed by one or more other systems or devices, including one or more of the devices of FIG. 3. Additionally, process 400 may include one or more fewer, additional, differently ordered and/or arranged operations than those shown in FIG. 4. In some implementations, some or all of the operations of process 400 may be performed independently, successively, simultaneously, etc., of one or more of the other operations of process 400. As such, the techniques described herein are not limited to a number, sequence, arrangement, timing, etc., of the operations or processes depicted in FIG. 4.

As shown, process 400 may include UE 310 receiving a resource allocation from base station 322 (at 410). Process 400 may include UE 310 receiving configuration information from base station 322 (at 420). The configuration information may include RRC information, DCI information, L1 signaling, and/or one or more other types of configuration information. The configuration information may include various types of instructions, parameters, and resource allocation information. UE 310 may use the configuration information to determine a communication scheme, resource configuration, etc., for communicating to engage in SBFD communication, non-SBFD communications, and/or a combination thereof (at 440).

In some implementations, the configuration information may cause or enable UE 310 to transmit SRS via a UL sub-band of an SBFD communication. In some implementations, the configuration information may include an indication of a type 0 FDRA scheme or a type 1 FDRA scheme. The configuration information may also cause or enable UE 310 to use a PUSCH for SBFD communications according to the indicate FDRA scheme.

In some implementations, the configuration may include instructions and/or parameters for a type 1 CG or a type 2 CG for a PUSCH. In such a scenario, the configuration information may include two parameters, one for non-SBFD communications (e.g., TDD) and the other for SBFD communications. In some implementations, the configuration information may include one set of parameters and one or more delta parameters, from which UE 210 may produce a second set of parameters by applying the delta parameter(s) one or more of the received parameters.

In such a scenario, the received set of parameters and the produced set of parameters may be used for non-SBFD communications and SBFD communications. In some implementations, the configuration information may include instructions and parameters for multi-grant PUSCHs and/or multi-grant PDSCHs. The configuration information may include multiple MCS parameters that may be applied to non-SBFD communications and SBFD communications. In other implementations, a single MCS parameter may be provided with a delta-value, from which UE 310 may determine a second MSC parameter so that different MSC parameters may be applied to non-SBFD communications and SBFD communications.

UE 310 may implement SBFD to communicate with base station 322 (at 480). For example, UE 310 may use the configuration information to implement one or more transmission and reception schemes to communicate with base station via one or more communication channels. The communications schemes may include a non-SBFD communications, an SBFD communications, or a combination thereof. Additional details and examples of these and other techniques are described below with reference to the Figures that follow.

The techniques described herein may include enhancement to transmitting SRS in SBFD. Generally, there are couple of parameters that may determine SRS sequence mapping into physical PRBs. These parameters may include freqDomainPosition (n_{RRC}) parameter, a freqDomainShift (nshift), etc. The parameter freqDomainShift (nshift) may be given in units of RBs and may adjust the SRS allocation with respect to the reference point grid. When the parameter nshift is greater than or equal to the parameter NBwp^{start} then a reference point for SRS RE mapping becomes subcarrier 0 in common resource block 0. Otherwise, the reference point may be the lowest subcarrier of the BWP.

SRS transmitted using SBFD are allocated a sub-band for UL transmissions, not a BWP. As such, for an SRS in a UL sub-band of an SBFD scenario, when N_{SHIFT} is greater than or equal to N_{ULSB}^{start}, UE 310 may determine that the reference point for SRS RE mapping may be subcarrier 0 in a common resource block 0. When N_{SHIFT} is less than N_{ULSB}^{start}, UE 310 may determine that the reference point may be the lowest subcarrier of the start. UE UL sub-band. In other implementations, when N_{SHIFT} is greater than or equal to N_{ULSB}^{start}, UE 310 may not use RBs or Res for SRS that are outside of the UL sub-band. In other implementations, UE 310 may still use the assigned UL sub-band for the SRS regardless of, start for example, whether N_{SHIFT} is greater than or equal to N_{ULSB}^{start}.

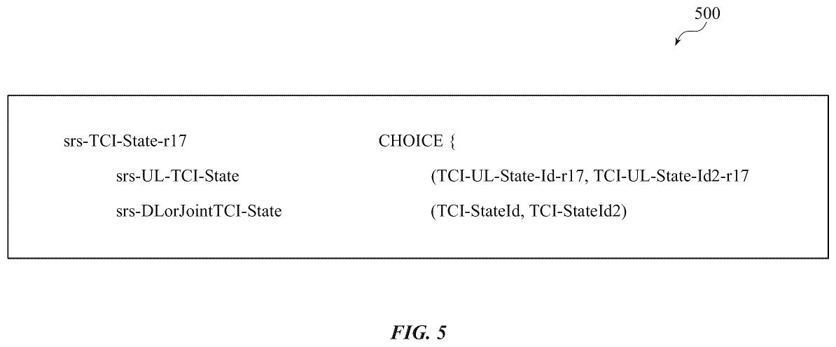

FIG. 5 is a diagram of an example 500 of information element (IE) and/or parameters for transmission indicator states (TCIs) for SBFD according to one or more implementations described herein. For SBFD operations, since some antenna elements may be used for DL transmission and some for simultaneous UL reception at base station, UL and DL beam correspondence toward UE 310 may change for SBFD and non-SBFD symbols and slots. That is, UE 310 may use different TCIs for SRS transmissions in SBFD and SRS transmissions in non-SBFD. In addition, SRS transmission in SBFD and non-SBFD symbols or slots may involve different UL transmission powers. TCI states may be dynamically sent via DCI, which may include configurations such as quasi co-location (QCL) relationships between the DL reference signals (RS) in one channel state information (CSI) RS (CSI-RS) set and the PDSCH demodulated RS (DMRS) ports.

In some implementations, UE 310 may be configured with two TCI-UL state IDs (e.g., two TCI-UL-State-Ids) or two TCI state IDs (e.g., two TCI-StateIds) within an SRS-resource. In some implementations, UE 310 may determine that one ID corresponds to a TCI for SRS transmission for non-SBFD (e.g., TDD) symbols, and another ID corresponds to a different TCI for SRS transmission for SBFD symbols. When a single TCI ID is configured for an SRS-Resource, UE 310 may apply the TCI to SRS transmissions for both symbol types.

As show, example 500 may include an srs-TCI-State IE with multiple TCI UL states for SRS (e.g., TCI-UL-State-Id-r17 and TCI-UL-State-Id2) and multiple TCI DL states for SRS (e.g., TCI-UL-State-Id and TCI-UL-State-Id2). As such, different TCIs associated to SRS via different symbol or slot types (SBFD and non-SBFD) may be associated with different UL power control parameters (P0, alpha, pathloss (PL), etc.).

FDRA may include a process whereby UL resources are assigned to UE 310 for PUSCH communications. Base station 322 may assign the resources using DCI format 0_0, DCI format 0_1, etc., via the PDCCH physical channel. An FDRA field within the DCI may be used to specify the set of allocated RBs. The frequencyDomainAllocation IE within the RRC signaling protocol may be used to specify the set of allocated RBs when using CG resource allocations.

FDRA may consist of type 0 and type 1. Type 0 may include a scheme using a bitmap to allocate specific RBGs. A RBG is a set of contiguous virtual resource blocks. However, because of the bitmap the RBGs in type 0 FDRA need not be contiguous. The first RBG and the last RBG may be of different sizes depending on the BWP starting RB and the BWP size. Type 0 FDRA may be communicated using DCI format 0_0 and/or with transform pre-coding. Type 1 may include a scheme that uses a resource indication value (RIV) to configure a set of contiguous virtual resource blocks. This scheme may be implemented using DCI format 0_0, 0_1, or RRC signaling. The DCI may indicate a starting RB and a length of allocation (SLIV) with respect to a BWP.

A resourceAllocation IE may be used to specify resource allocation scheme. In case of dynamic resource allocations, this IE may be included in a PUSCH-Config 1E. In case of CG resource allocations, this information may be included in a ConfiguredGrantConfig 1E. A resource Allocation IE may have values of Type 0, Type 1, and dynamicSwitch. In case of Type 1 CG resource allocation, this IE may not switch dynamically. When using a dynamicSwitch IE one additional bit may be added within DCI to indicate the scheme being used. RRC signaling may be used to configure up to 4 BWP in addition to an BWP. When UE 310 receives the FDRA, UE 310 may first identify the BWP and then identify the corresponding resource allocation.

Non-SBFD transmissions may involve a FDRA that include a BWP allocated to UE 310. In such scenarios, UE 310 may determine RBs and RBGs of the FDRA relative to the BWP for the PUSCH transmission. One or more of the techniques described herein, include solutions for SBFD transmissions that may involve a FDRA that include a BWP, or a sub-band allocated to UE 310. In some scenarios, UE 310 may determine RBs and RBGs of the FDRA relative to the BWP or the or the sub-band allocated.

Some scenarios may involve a type 0 FDRA procedure. In some implementations, UE 310 may determine a nominal RBG size based on a size of a corresponding UL sub-band. For example, in a non-SBFD scenario, UE 310 may determine the size of a nominal RBG based on a size of the corresponding BWP. In an SBFD scenario, UE 310 may determine the size of a nominal RBG based on a size of a. corresponding UL sub-band (e.g., instead of the size of the BWP). In other implementations, UE 310 may determine the size of a nominal RBG based on a size of the corresponding BWP for both SBRD and non-SBFD scenarios.

One or more of the techniques for SBFD, as described herein, may include the transmission of SBFD symbols corresponding to a type 1 FRRA procedure. In some implementations, UE 310 may interpret the SLIV for the UL sub-band based on the UL sub-band size. SLIV may include a starting symbol S (within a slot) and a length L of the resource allocation. This combination may be given by a single number following a specific formulation (e.g., so UE 310 may do reverse engineering to map the indicated number of S and L). In some implementations, in other implementations, UE 310 may interpret the SLIV for the UL sub-band based on the UL BWP size. SLIV may include a starting symbol S (within a slot) and a length L of the resource allocation. This combination may be given by a single number following a specific formulation (e.g., so UE 310 may do reverse engineering to map the indicated number of S and L). In such scenarios, when an FDRA allocation (e.g., the SLIV) extends beyond the UL sub-band the PUSCH may be dropped.

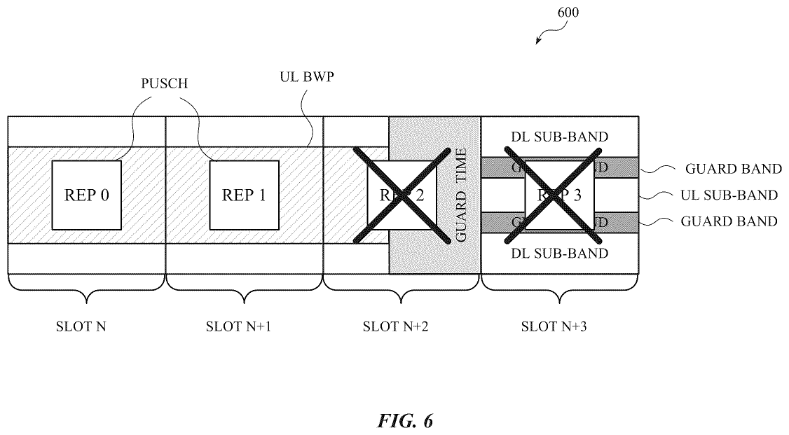

FIG. 6 is a diagram of an example 600 of resources of non-SBFD slots and SBFD slots according to one or more implementations described herein. As shown, example 500 may include slot N, slot N+1, slot N+2, and slot N+3. Slot N and N+1 nay each be non-SBFD slots (e.g., TDD slots); slot N+2 may include a transition slot; and slot N+3 may be an SBFD slot. Slot N and N+1 nay include a UL BWP used for repetition 0 and repletion 1 of a PUSCH. Slot N+2 may include a transition slot, a first portion of which includes a BWP and a later portion of which includes a guard time. The guard time may include resources that are not used for signaling to reduce interference or signal noise when UE 310 transitions from non-SBFD slots to SBFD slots. Slot N+3 may include an SBFD slot and may therefore include DL sub-bands, guard bands, and a UL sub-band.

In some implementations, for PUSCH repetitions that span both SBFD and non-SBFD slots, the FDRA may be consistent and may be determined based on symbol time in the first repetition occasion. When an FDRA from a non-SBFD repetition does not fit into an UL sub-band in the SBFD occasion, the PUSCH repetition may be dropped. For example, as PUSCH repetition 2 does not fit in a BWP of slot N+2, UE 310 may not transmit PUSCH repetition 2. Similarly, as PUSCH repetition 3 does not fit in a US sub-band of slot N+3, UE 310 may not transmit PUSCH repetition 3. In other implementations, when an FDRA from a non-SBFD repetition does not fit into an UL sub-band in the SBFD occasion, UE may perform rate matching on the non-SBFD slots. For example, UE 310 may continue the PUSCH repetition using the UL resources of the SBFD symbols.

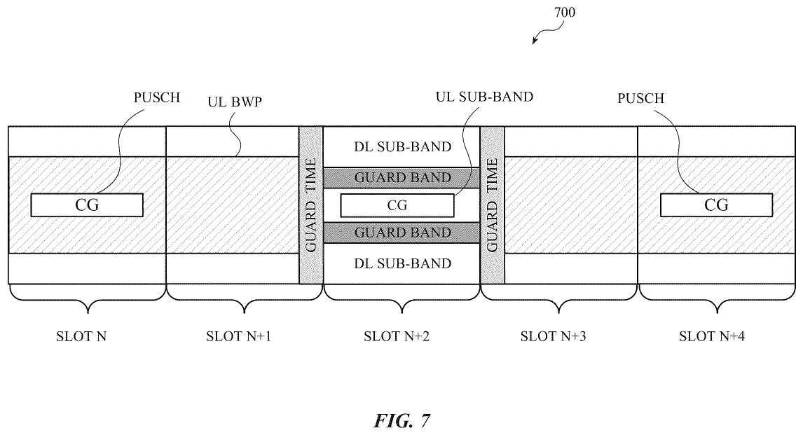

FIG. 7 is a diagram of an example 700 of resources of non-SBFD slots and SBFD slots according to one or more implementations described herein. As shown, example 600 may include slot N, slot N+1, slot N+2, slot N+3, and slot N+4. Slot N and slot N+4 nay each be non-SBFD slots (e.g., TDD slots) with a BWP portion. Slot N+1 and slot N+3 may be transition slots that include a BWP portion and a guard time portion. Slot N+2 may be an SBFD slot and may include DL sub-bands, guard bands, and a UL sub-band. Slot N, slot N+2, and slot N+4 may each include a CG for a PUSCH (or CG-PUSCH).

As shown, UE 310 may be configured with a CG-PUSCH. An RRC periodicity parameter may be 2 slots (e.g., sym2×14). The first and third CG_PUSCH of slots N and N+4 correspond to legacy TDD slots that may use a first MCS for transmissions. The second CG_PUSCH of slot N+2 corresponds to an SBFD slot that may use a different MSC for transmission. As described below, UE 310 may determine the different MCS in one or more ways, which may depend on whether CG is a. type 1 CG or a type 2 CG.

As shown, the CG-PUSCH may involve non-SBFD slots (N and N+4) and an SBFD slot (N+2). Different types of control information may be used to allocate appropriate resources to UE 310 and/or configured UE 310 to use the resources appropriately. For example, a CG for a PUSCH may be a type 1 CG or a type 2 CG. A type 1 CG may be sent via RRC signaling. A type 2 CG may be a mix of RRC signaling and layer 1 (L1) signaling. For an activated CG-PUSCH, where different repetitions may span different slot types (e.g., non-SBFD slots and SBFD slots), different CG-PUSCH parameters may be used to allocated resources. This may be due to one or more factors, such as UE 310 using different power control parameters, signal interference at base station 322, wider beam indications for SBFD slots than for non-SBFD slots, etc.

For a type 1 CG-PUSCH, configuration information (e.g., a ConfiguredGrantConfig 1E) may include a pair of parameters in one or more fields. One parameter value in the field may be for CG-PUSCH transmission in non-SBFD slots, and the other parameter value in the field may be for CG-PUSCH transmission in SBFD slots. Examples of such fields and parameters may include:

(p0-PUSCH-Alpha, p0-PUSCH-Alpha2),
(timeDomainAllocation, timeDomainAllocation2),
(precodingAndNumberOfLayers, precodingAndNumberOfLayers2),
(srs-ResourceIndicator, srs-ResourceIndicator2),
(mcsAndTBS, mcsAndTBS2),
(frequencyHoppingOffset, frequencyHoppingOffset2), and/or
(pathlossReferenceIndex, pathlossReferenceIndex2).

A p0-PUSCH-Alpha parameter may indicate transmission power information for the PUSCH. A timeDomainAllocation parameter may indicate time domain information for the PUSCH. A precodingAndNumberOfLayers parameter may indicate precoding and layers information for the PUSH. A srs-ResourceIndicator parameter may indicate resources allocated to SRS. A mcsAndTBS parameter may indicate information about a modulation and coding scheme (MCS) and transport block size for the PUSCH. A frequencyHoppingOffset parameter may indicate information about frequency offsets for the PUSCH. A pathlossReferenceIndex parameter may indicate information about a path loss associated with the PUSCH.

For a type 2 CG-PUSCH, UE 310 may be additionally configured with some parameters that are originally indicated by the activation DCI. In such scenarios, the activation DCI may indicate PUSCH parameters for many or all occasions that have the same symbol type as the first PUSCH (e.g., coming with the activation DCI). For example, when the first PUSCH is transmitted in an SBFD slot, all CG-PUSCHs within SBFD slots may follow the same parameters in terms of one or more of a target received power (Po or P0) at the receiver, a path loss (PL) compensation factor (alpha or α), a path loss (PL), an SRS resource indicator (SRI), a transmitted precoder matrix indicator (TPMI), an MCS, a time domain resource allocation (TDRA), etc.

In some implementations, the configured parameters may also be applied to different type of slots (e.g., non-SBFD slots) that also include the CG-PUSCH. For instance, when the first PUSCH is transmitted in an SBFD slot, non-SBFD slots with the PUSCH will apply the configured parameters for the SBFD slot. Alternatively, UE 310 may determine different parameters for the other type of slots.

In some implementations, UE 310 may apply one or more delta values to the configured parameters for the one type of slot to determine suitable configured parameters for the other type of slot. For example, when UE 310 is configured with a delta_mcs parameter, when the first PUSCH coming with the activation DCI is transmitted in SBFD slots, CG-PUSCHs in SBFD slots may have the same MCS indicated by DCI while CG-PUSCHs in non-SBFD slots may have a different MCS based on the MCS value in the DCI and the delta value for MCS values (e.g., MCS+delt_mcs). Delta values for multiple parameters may be received and applied.

In some implementations, UE 310 may be configured with DCI that includes parameters for CG-PUSCGs in SBFD slots (or non-SBFD slots) regardless of the type of slot with the first PUSCH. For example, UE 310 may be configured with a delta_mcs, and all CG-PUSCHs in non-SBFD slots (or (or SBFD slots) may have a separate MCS, which UE 310 may determine based on the MCS value of the DCI and the delta-mcs value (e.g., MCS+delt_mcs). Delta values for multiple parameters may be received and applied.

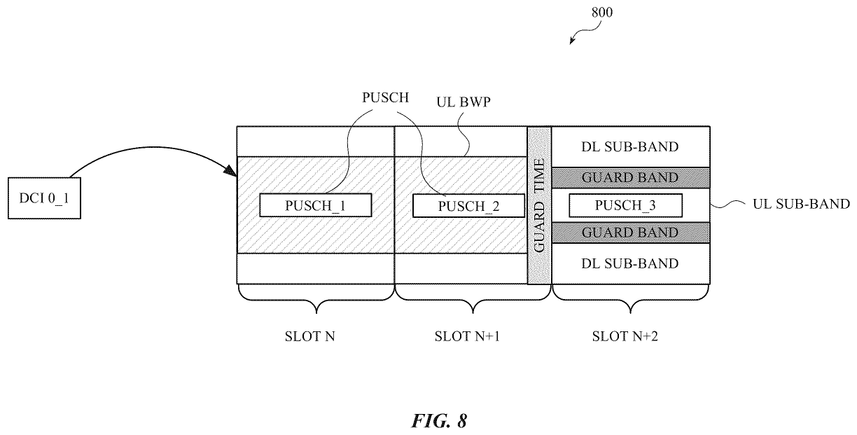

FIG. 8 is a diagram of an example 800 of resources of non-SBFD slots and SBFD slots according to one or more implementations described herein. As shown, example 700 may include slot N, slot N+1, and slot N+2. Slot N and slot N+1 nay each be non-SBFD slots (e.g., TDD slots) with a BWP portion. Slot N+1 may have a guard time. Slot N+2 may be an SBFD slot and may include DL sub-bands, guard bands, and a UL sub-band. Slot N, slot N+1, and slot N+2 may each include a PUSCH (PUSCH 1, PUSCH 2, and PUSCH 3). The PUSCH may correspond to the BWP of claims slot N and slot N+1. The PUSCH may correspond to a UL band in slot N+2.

As shown, UE 310 may receive from base station 322 configuration information (e.g., DCI) that include a multi-grant PUSCH (e.g., the 3 grants depicted in FIG. 7). UE 310 may determine that PUSCH land PUSCH 2 correspond to non-SBFD slots (e.g., legacy TDD slots) and that PUSCH 3 corresponds to an SBFD slot. In response, UE 310 may interpret FDRA parameters for slot N and slot N+1 according to the BWP being used for PUSCH 1 and PUSCH 2. By contrast, UE 310 may interpret FDRA parameters for slot N and slot N+1 according to the UL sub-band being used for PUSCH 3.

Base station 322 may use a single instance or set of DCI to schedule multiple PDSCHs (or PUSCHs). Most of the parameters may be the same across different grants (e.g., they follow the same MCS, FDRA, etc.) although TDRA, SLIV, etc., may be different for different grants. As described herein, DCI for multi-grant scheduling can have two different MCS fields for PDSCHs (or PUSCHs) in SBFD and non-SBFD slots. In some implementations, one MCS bit-field may be applied to grants in SBFD slots, and another bit-field may be applied to grants in non-SBFD slots. Alternatively, DCI may indicate one MCS and a delta_mcs value may be applied to the MSC to create a second MCS, such that SBFD and non-SBFD slots may have different MSCs. The single MCS in the DCI may indicate the MCS for PUSCH (or PDSCH) grants with the same symbol type as the first PUSCH (or PDSCH). The MCS for PUSCHs (or PDSCHs) with a different symbol type from the first PUSCH (or PDSCH) may be determined by applying MCS+delta_mcs.

In some implementations, DCI for multi-grant scheduling can have two different FDRA fields for PDSCHs (or PUSCHs) in SBFD and non-SBFD slots. One FDRA bit-field may be applied to grants in SBFD slots, and the other bit-field may be applied to grants in non-SBFD slots. In some implementations, UE 310 may interpret a single FDRA bit-field in DCI differently for grants involving SBFD slots and non-SBFD slots. UE 310 may determine a size of the FDRA bit-field in DCI based on a slot or symbol type of the first slot or symbol of the grant. A size of a DL BWP in in a legacy TDD slot may be larger than a DL sub-band size in SBFD slot. Thus, a fewer number of bits may be used to indicate a FDRA in an SBFD slot relative to a TDD slot. When the first PUSCH grant is within a non-SBFD slot, FDRA bit-field size may be determined based on the corresponding UL BWP.

When the first PUSCH grant is within an SBFD slot, FDRA bit-field size may be determined based on the corresponding UL sub-band. In some implementations, FDRA for SBFD slots may be scaled accordingly. For example, a UL sub-band may be half of a UL BWP, thus any allocation in a frequency domain may be scaled by one half in an SBFD slot relative to a legacy TDD slot. In other implementations, FDRA DCI bit-field size may be determined based on a minimum of required bits of the two symbol or slot types (SBFD and non-SBFD). The FDRA for the symbol or slot type with more required bits is scaled accordingly. As such, a size of an FDRA bit field may depend on a UL BWP size in non-SBFD (or UL sub-band size in SBFD). For example, a UL sub-band may be half of a UL BWP. In such a scenario, an FDRA bit-field may be determined based on a UL sub-band but the allocation in frequency may be scaled by 2 for a legacy TDD slot. In yet other implementations, UE 310 may determine a size of the FDRA bit-field in DCI based on a minimum of required bits of the two symbol or slot types (SBFD and non-SBFD). The FDRA for the symbol or slot type with less required bits may obtained by re-interpretation of DCI (e.g., by padding one or more bits to zero or a zero index position).

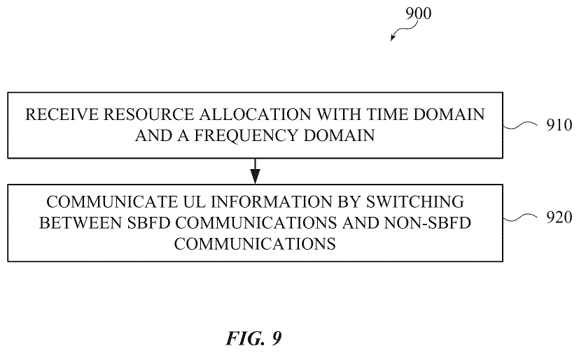

FIG. 9 is a diagram of an example process 900 for SBFD resource allocation from the perspective of a user equipment (UE) according to one or more implementations described herein. Process 900 may be implemented by UE 310. In some implementations, some or all of process 900 may be performed by one or more other systems or devices, including one or more of the devices of FIG. 3. Additionally, process 900 may include one or more fewer, additional, differently ordered and/or arranged operations than those shown in FIG. 9. In some implementations, some or all of the operations of process 900 may be performed independently, successively, simultaneously, etc., of one or more of the other operations of process 900. As such, the techniques described herein are not limited to a number, sequence, arrangement, timing, etc., of the operations or processes depicted in FIG. 9.

As shown, process 900 may include UE 310 receiving, from a base station, a resource allocation that includes a time domain and a frequency domain (block 910). Process 900 may also include communicating, to the base station, UL information by switching between SBFD communications and non-SBFD communications within the time domain of the resource allocation (block 920). One or more additional or alternative operations may be included in process 900, such as receiving configuration information (e.g., RRC information, DCI information, etc.) and switching between SBFD communications and non-SBFD communications based on the configuration information.

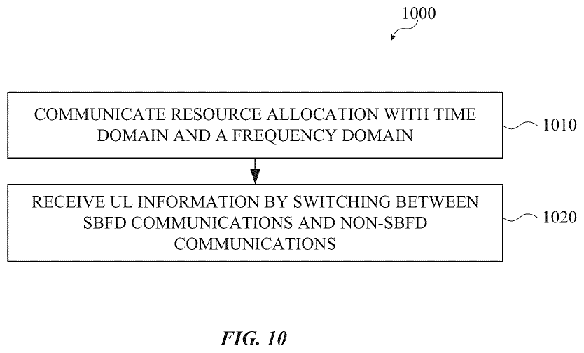

FIG. 10 is a diagram of an example process 1000 for SBFD resource allocation from the perspective of a base station according to one or more implementations described herein. Process 1000 may be implemented by base station 322. In some implementations, some or all of process 1000 may be performed by one or more other systems or devices, including one or more of the devices of FIG. 3. Additionally, process 1000 may include one or more fewer, additional, differently ordered and/or arranged operations than those shown in FIG. 10. In some implementations, some or all of the operations of process 1000 may be performed independently, successively, simultaneously, etc., of one or more of the other operations of process 1000. As such, the techniques described herein are not limited to a number, sequence, arrangement, timing, etc., of the operations or processes depicted in FIG. 10.

As shown, process 1000 may include base station 322 sending, to UE 310, a resource allocation that includes a time domain and a frequency domain (block 1010). Process 1000 may also include receiving, from UE 310, UL information by switching between SBFD communications and non-SBFD communications within the time domain of the resource allocation (block 1020). One or more additional or alternative operations may be included in process 1000, such as sending configuration information (e.g., RRC information, DCI information, etc.) and UE 310 switching between SBFD communications and non-SBFD communications based on the configuration information.

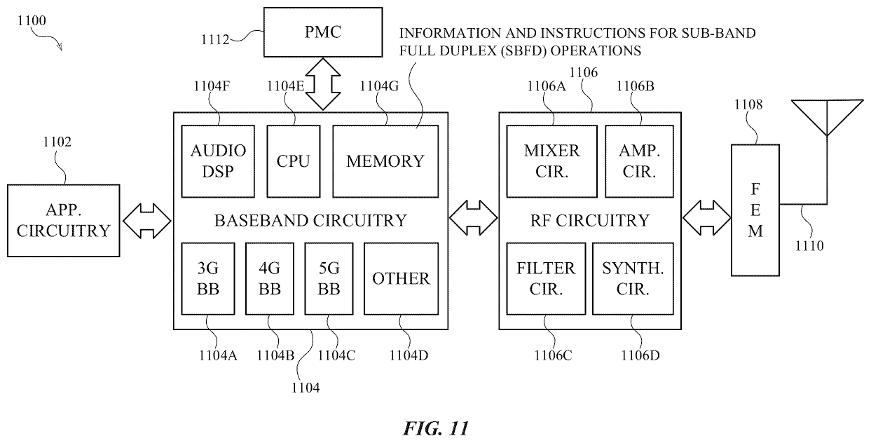

FIG. 11 is a diagram of an example of components of a device 1100 according to one or more implementations described herein. In some implementations, device 1100 can include application circuitry 1102, baseband circuitry 1104, RF circuitry 1106, front-end module (FEM) circuitry 1108, one or more antennas 1110, and power management circuitry (PMC) 1112 coupled together at least as shown. In some implementations, device 1100 can include fewer elements (e.g., a RAN node may not utilize application circuitry 1102 and can instead include a processor/controller to process data received from a core network. In some implementations, device 1100 can include additional elements such as, for example, memory/storage, display, camera, sensor (including one or more temperature sensors, such as a single temperature sensor, a plurality of temperature sensors at different locations in device 1100, etc.), or input/output (I/O) interface. In other implementations, the components described below can be included in more than one device (e.g., said circuitries can be separately included in more than one device for cloud-RAN (C-RAN) implementations).

Application circuitry 1102 can include one or more application processors. For example, application circuitry 1102 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on device 1100. In some implementations, processors of application circuitry 1102 can process data packets received from a core network.

Baseband circuitry 1104 can include circuitry such as, but not limited to, one or more single-core or multi-core processors. Baseband circuitry 1104 can include one or more baseband processors or control logic to process baseband signals received from a receive signal path of RF circuitry 1106 and to generate baseband signals for a transmit signal path of RF circuitry 1106. Baseband circuitry 1104 can interface with application circuitry 1102 for generation and processing of the baseband signals and for controlling operations of RF circuitry 1106. For example, in some implementations, baseband circuitry 1104 can include a 3G baseband processor 1104A, a 4G baseband processor 1104B, a 5G baseband processor 1104C, or other baseband processor(s) 1104D for other existing generations, generations in development or to be developed in the future (e.g., 5G, 6G, 7G, etc.). Baseband circuitry 1104 (e.g., one or more of baseband processors 1104A-D) can handle various radio control functions that enable communication with one or more radio networks via RF circuitry 1106. In other implementations, some or all of the functionality of baseband processors 1104A-D can be included in modules stored in memory 1104G and executed via a central processing unit (CPU) 1104E. The radio control functions can include, but are not limited to, signal modulation/demodulation, encoding/decoding, radio frequency shifting, etc. In some implementations, modulation/demodulation circuitry of baseband circuitry 1104 can include Fast-Fourier Transform (FFT), precoding, or constellation mapping/de-mapping functionality. In some implementations, encoding/decoding circuitry of baseband circuitry 1104 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 1104G can receive and/or store information and instructions for SBFD operations. This may include causing or enabling UE 310 to switch between SBFD communications and non-SBFD communications within the same time domain of a resource allocation. SRS, PUSCH, and type 1 and type 2 CG scenarios may be involved. Also included may be the transmission and/or reception of RRC information, DCI, L1 indicators, and/or one or more other types of control information.

In some implementations, baseband circuitry 1104 can include one or more audio digital signal processor(s) (DSP) 1104F. Audio DSP 1104F can include elements for compression/decompression and echo cancellation and can include other suitable processing elements in other implementations. Components of baseband circuitry 1104 can be suitably combined in a single chip, a single chipset, or disposed on a same circuit board in some implementations. In some implementations, some or all of the constituent components of baseband circuitry 1104 and application circuitry 1102 can be implemented together such as, for example, on a system on a chip (SOC).

In some implementations, baseband circuitry 1104 can provide for communication compatible with one or more radio technologies. For example, in some implementations, baseband circuitry 1104 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which baseband circuitry 1104 is configured to support radio communications of more than one wireless protocol can be referred to as multi-mode baseband circuitry.

RF circuitry 1106 can enable communication with wireless networks using modulated electromagnetic radiation through a non-solid medium. In various implementations, RF circuitry 1106 can include switches, filters, amplifiers, etc., to facilitate the communication with the wireless network. RF circuitry 1106 can include a receive signal path which can include circuitry to down-convert RF signals received from FEM circuitry 1108 and provide baseband signals to baseband circuitry 1104. RF circuitry 1106 can also include a transmit signal path which can include circuitry to up-convert baseband signals provided by baseband circuitry 1104 and provide RF output signals to FEM circuitry 1108 for transmission.

In some implementations, the receive signal path of RF circuitry 1106 can include mixer circuitry 1106A, amplifier circuitry 1106B and filter circuitry 1106C. In some implementations, the transmit signal path of RF circuitry 1106 can include filter circuitry 1106C and mixer circuitry 1106A. RF circuitry 1106 can also include synthesizer circuitry 1106D for synthesizing a frequency for use by mixer circuitry 1106A of the receive signal path and the transmit signal path. In some implementations, mixer circuitry 1106A of the receive signal path can be configured to down-convert RF signals received from FEM circuitry 1108 based on the synthesized frequency provided by synthesizer circuitry 1106D. Amplifier circuitry 1106B can be configured to amplify the down-converted signals and filter circuitry 1106C can be a low-pass filter (LPF) or band-pass filter (BPF) configured to remove unwanted signals from the down-converted signals to generate output baseband signals. Output baseband signals can be provided to baseband circuitry 1104 for further processing. In some implementations, the output baseband signals can be zero-frequency baseband signals, although this may not be a requirement. In some implementations, mixer circuitry 1106A of the receive signal path can comprise passive mixers, although the scope of the implementations is not limited in this respect.

In some implementations, mixer circuitry 1106A of the transmit signal path can be configured to up-convert input baseband signals based on the synthesized frequency provided by synthesizer circuitry 1106D to generate RF output signals for FEM circuitry 1108. The baseband signals can be provided by baseband circuitry 1104 and can be filtered by filter circuitry 1106C. In some implementations, mixer circuitry 1106A of the receive signal path and mixer circuitry 1106A of the transmit signal path can include two or more mixers and can be arranged for quadrature down conversion and up conversion, respectively. In some implementations, mixer circuitry 1106A of the receive signal path and mixer circuitry 1106A of the transmit signal path can include two or more mixers and can be arranged for image rejection. In some implementations, mixer circuitry 1106A of the receive signal path and mixer circuitry 1106A can be arranged for direct down conversion and direct up conversion, respectively. In some implementations, mixer circuitry 1106 of the receive signal path and mixer circuitry 1106A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 1106 can include analog-to-digital converter (ADC) and digital-to-analog converter (DAC) circuitry and baseband circuitry 1104 can include a digital baseband interface to communicate with RF circuitry 1106.

In some dual-mode implementations, a separate radio IC circuitry can be provided for processing signals for each spectrum, although the scope of the implementations is not limited in this respect. In some implementations, synthesizer circuitry 1106D can be a fractional-N synthesizer or a fractional N/N+1 synthesizer, although the scope of the implementations is not limited in this respect as other types of frequency synthesizers can be suitable. For example, synthesizer circuitry 1106D can be a delta-sigma synthesizer, a frequency multiplier, or a synthesizer comprising a phase-locked loop with a frequency divider.

Synthesizer circuitry 1106D can be configured to synthesize an output frequency for use by mixer circuitry 1106A of RF circuitry 1106 based on a frequency input and a divider control input. In some implementations, synthesizer circuitry 1106D can be a fractional N/N+1 synthesizer. In some implementations, frequency input can be provided by a voltage-controlled oscillator (VCO). Divider control input can be provided by either baseband circuitry 1104 or the applications circuitry 1102 depending on the desired output frequency. In some implementations, a divider control input (e.g., N) can be determined from a look-up table based on a channel indicated by the applications circuitry 1102.

Synthesizer circuitry 1106D of RF circuitry 1106 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1106D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 1106 can include an in-phase/quadrature (I/Q)/polar converter.

FEM circuitry 1108 can include a receive signal path which can include circuitry configured to operate on RF signals received from one or more antennas 1110, amplify the received signals and provide the amplified versions of the received signals to RF circuitry 1106 for further processing. FEM circuitry 1108 can also include a transmit signal path which can include circuitry configured to amplify signals for transmission provided by RF circuitry 1106 for transmission by one or more of the one or more antennas 1110. In various implementations, the amplification through the transmit or receive signal paths can be done solely in RF circuitry 1106, solely in FEM circuitry 1108, or in both RF circuitry 1106 and FEM circuitry 1108.

In some implementations, FEM circuitry 1108 can include a transmit/receive switch to switch between transmit mode and receive mode operation. FEM circuitry 1108 can include a receive signal path and a transmit signal path. The receive signal path of FEM circuitry 1108 can include a low noise amplifier to amplify received RF signals and provide the amplified received RF signals as an output (e.g., to RF circuitry 1106). The transmit signal path of FEM circuitry 1108 can include a power amplifier to amplify input RF signals (e.g., provided by RF circuitry 1106), and one or more filters to generate RF signals for subsequent transmission (e.g., by one or more of one or more antennas 1110).

In some implementations, PMC 1112 can manage power provided to baseband circuitry 1104. In particular, PMC 1112 can control power-source selection, voltage scaling, battery charging, or direct current (DC) to DC (DC-to-DC) conversion. PMC 1112 can often be included when device 1100 is capable of being powered by a battery, for example, when device 1100 is included in a UE. PMC 1112 can increase the power conversion efficiency while providing desirable implementation size and heat dissipation characteristics.

While FIG. 11 shows PMC 1112 coupled only with baseband circuitry 1104. However, in other implementations, PMC 1112 can be additionally or alternatively coupled with, and perform similar power management operations for, other components such as, but not limited to, application circuitry 1102, RF circuitry 1106, or FEM circuitry 1108.

In some implementations, PMC 1112 can control, or otherwise be part of, various power saving mechanisms of device 1100. For example, if device 1100 is in an RRC_Connected state, where device 1100 is still connected to the RAN node as device 1100 expects to receive traffic shortly, then device 1100 can enter a state known as discontinuous reception mode (DRX) after a period of inactivity. During this state, device 1100 can power down for brief intervals of time and thus save power.

If there is no data traffic activity for an extended period of time, then device 1100 can transition off to an RRC_Idle state, where device 1100 disconnects from the network and does not perform operations such as channel quality feedback, handover, etc. Device 1100 can go into a very low power state and device 1100 can perform paging where again device 1100 periodically can wake up to listen to the network and then power down again. Device 1100 may not receive data in this state; in order to receive data, device 1100 can transition back to RRC_Connected state.

An additional power saving mode can allow a device to be unavailable to the network for periods longer than a paging interval (ranging from seconds to a few hours). During this time, the device 1100 can be unreachable to the network and can power down completely. Any data sent during this time can incur a large delay and device 1100 can assume the delay is acceptable.

Processors of application circuitry 1102 and processors of baseband circuitry 1104 can be used to execute elements of one or more instances of a protocol stack. For example, processors of baseband circuitry 1104, alone or in combination, can be used execute Layer 3, Layer 2, or Layer 1 functionality, while processors of baseband circuitry 1104 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

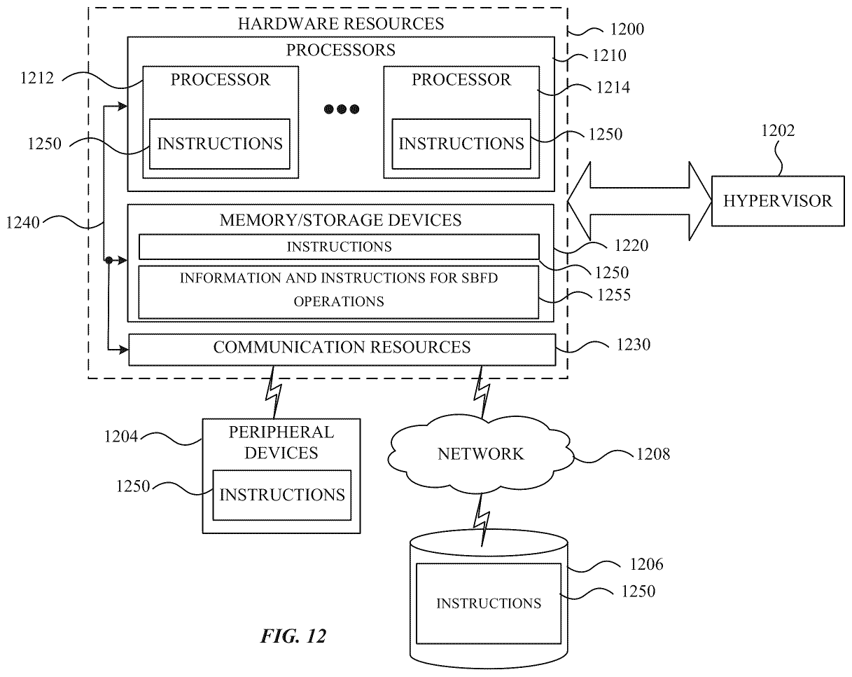

FIG. 12 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1200 including one or more processors 1210 (or processor cores), one or more memory/storage devices 1220, and one or more communication resources 1230, each of which can be communicatively coupled via a bus 1240. For implementations where node virtualization or network function virtualization is utilized, a hypervisor can be executed to provide an execution environment for one or more network slices/sub-slices to utilize hardware resources 1200. Hardware resources 1200 can interact with hypervisor 1202. For example, hypervisor 1202 can schedule or otherwise manage hardware resource 1200.

Processors 1210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1212 and a processor 1214.

Memory/storage devices 1220 can include main memory, disk storage, or any suitable combination thereof. Memory/storage devices 1220 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), flash memory, solid-state storage, etc.

In some implementations, memory/storage devices 1220 receive and/or store information and instructions 1255 for SBFD operations. This may include causing or enabling UE 310 to switch between SBFD communications and non-SBFD communications within the same time domain of a resource allocation. SRS, PUSCH, and type 1 and type 2 CG scenarios may be involved. Also included may be the transmission and/or reception of RRC information, DCI, L1 indicators, and/or one or more other types of control information

Communication resources 1230 can include interconnection or network interface components or other suitable devices to communicate with one or more peripheral devices 1204 or one or more databases 1206 via a network 1208. For example, communication resources 1230 can include wired communication components (e.g., for coupling via a universal serial bus), cellular communication components, near field communication components, Bluetooth® components (e.g., Bluetooth® Low Energy), Wi-Fi® components, and other communication components.

Instructions 1250 can comprise software, a program, an application, an applet, an app, or other executable code for causing at least any of processors 1210 to perform any one or more of the methodologies discussed herein. Instructions 1250 can reside, completely or partially, within at least one of processors 1210 (e.g., within a cache memory), memory/storage devices 1220, or any suitable combination thereof. Furthermore, any portion of instructions 1250 can be transferred to hardware resources 1200 from any combination of peripheral devices 1204 or databases 1206. Accordingly, memory of processors 1210, memory/storage devices 1220, peripheral devices 1204, and databases 1206 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user device (UE) may comprise: a memory; and one or more processors configured to, when executing instructions stored in the memory, cause the UE to: receive, from a base station, a resource allocation that includes a time domain and a frequency domain; and communicate, to the base station, uplink (UL) information by switching between sub-band full duplex (SBFD) communications and non-SBFD communications within the time domain of the resource allocation.

In example 2, which may also include one or more of the examples described herein, the resource allocation indicates slots or symbols for the SBFD communications and the non-SBFD communications.

In example 3, which may also include one or more of the examples described herein, the non-SBFD communications are time division duplex (TDD) communications.

In example 4, which may also include one or more of the examples described herein, at least one of the SBFD communications includes a sounding reference signals (SRS), and a reference point for SRS resource element (RE) mapping is subcarrier 0 in common resource block 0, or a lowest subcarrier of a UL sub-band of the SBFD communications.

In example 5, which may also include one or more of the examples described herein, at least one of the SBFD communications includes a sounding reference signals (SRS), and the UE is configured to communicate the SRS using REs within a UL sub-band of the SBFD communication.

In example 6, which may also include one or more of the examples described herein, at least one of the SBFD communications includes a sounding reference signals (SRS), and the UE is configured to communicate the SRS regardless of whether N_{SHIFT} is greater than or equal to N_{ULSB}^{start}.

In example 7, which may also include one or more of the examples described herein, the UE is configured to receive configuration information and the configuration information comprises: a first transmission control indicators (TCI) UL-state-ID (TCI-UL-State-ID) corresponding to SRS via at least one of the SBFD communications, and a second TCI-UL-State-ID corresponding to the SRS via at least one of the non-SBFD communications.

In example 8, which may also include one or more of the examples described herein, the UE is configured to receive configuration information and the configuration information comprises: a first TCI is associated with a first set of power control parameters for SRS via at least one of the SBFD communications, and a second TCI is associated with a second set of power control parameters for SRS via at least one of the non-SBFD communications.

In example 9, which may also include one or more of the examples described herein, the resource allocation comprises a type 0 frequency domain resource assignment (FDRA) for a physical uplink shared channel (PUSCH), and the UE is configured to determine nominal resource block groups (RBGs) for the SBFD communications based on a size of a UL sub-band of the SBFD communications.

In example 10, which may also include one or more of the examples described herein, the resource allocation comprises a type 0 frequency domain resource assignment (FDRA) for a physical uplink shared channel (PUSCH), and the UE is configured to determine nominal resource block groups (RBGs) for the SBFD communications based on a size of a UL bandwidth part (BWP) of the non-SBFD communications.

In example 11, which may also include one or more of the examples described herein, the resource allocation comprises a type 1 frequency domain resource assignment (FDRA) for a physical uplink shared channel (PUSCH), and a start length indicator value (SLIV) for the SBFD communications is based on a size of a UL sub-band of the SBFD communications.

In example 12, which may also include one or more of the examples described herein, the resource allocation comprises a type 1 FDRA for a PUSCH, and a SLIV for the SBFD communications is based on a UL BWP size of the non-SBFD communications.

In example 13, which may also include one or more of the examples described herein, the resource allocation comprises a PUSCH with repetitions that spam the SBFD communications and the non-SBFD communications, and the UE is configured to drop the PUSCH during the SBFD communications when a FDRA of the PUSCH does not fit within a UL sub-band of the SBFD communications.

In example 14, which may also include one or more of the examples described herein, the UE is configured to receive configuration information and the configuration information comprises: a type 1 configuration grant (CG) for a PUSH (CG-PUSCH) with first parameters for the SBFD communications and second parameters for the non-SBFD communications.

In example 15, which may also include one or more of the examples described herein, the UE is configured to receive a first set of downlink (DL) control information (DCI) and a second set of DCI, the UE is configured to apply the first set of DCI to the SBFD communications or the non-SBFD communications based on which type of communication is first in a time domain of a PUSCH of the resource allocation, and the UE is configured to apply the first set of DCI to the SBFD communications or the non-SBFD communications based on which type of communication is second in the time domain of the PUSCH of the resource allocation.

In example 16, which may also include one or more of the examples described herein, the UE is configured to receive a first set of DCI and at least one delta value, the UE is configured to generate a second set of DCI by using the at least one delta value to modify the first set of DCI, and the UE is configured to apply the first set of DCI and the second set of DCI to the SBFD communications and the non-SBFD communications.

In example 17, which may also include one or more of the examples described herein, the UE is configured to receive DCI for multi-grant scheduling, the DCI comprising a first modulation and coding scheme (MCS) field for the SBFD communications and a second MCS field for the non-SBFD communications.

In example 18, which may also include one or more of the examples described herein, the UE is configured to receive DCI for multi-grant scheduling, the DCI comprising a first FDRA field for the SBFD communications and a second FDRA field for the non-SBFD communications.

In example 19, which may also include one or more of the examples described herein, the UE is configured to receive DCI for multi-grant scheduling, the DCI comprising an FDRA field with a size based on a UL sub-band of the SBFD communications or a BWP of the non-SBFD communications.

In example 20, which may also include one or more of the examples described herein, a method, performed by a user equipment (UE), may comprise operations according to one or more of the examples described herein.

In example 21, which may also include one or more of the examples described herein, a computer-readable medium, storing instruction configured to cause one or more processors to perform according to one or more of the examples described herein.

In example 22, which may also include one or more of the examples described herein, a baseband processor, comprising: a memory; and one or more processors configured to, when executing instructions stored in the memory, cause the baseband processor to perform according to one or more of the examples described herein.

In example 23, which may also include one or more of the examples described herein, a base station may comprise a memory; and one or more processors configured to, when executing instructions stored in the memory, cause the base station to: communicate, to a user equipment (UE), a resource allocation that includes a time domain and a frequency domain; and receive, from the UE, uplink (UL) information by switching between sub-band full duplex (SBFD) communications and non-SBFD communications within the time domain of the resource allocation.

In example 24, which may also include one or more of the examples described herein, the resource allocation indicates slots or symbols for the SBFD communications and the non-SBFD communications.

In example 25, which may also include one or more of the examples described herein, the non-SBFD communications are time division duplex (TDD) communications.

In example 26, which may also include one or more of the examples described herein, a method, performed by a base station, may comprise operations according to one or more of the examples described herein.

The examples discussed above also extend to method, computer-readable medium, and means-plus-function claims and implementations, an of which may include one or more of the features or operations of any one or combination of the examples mentioned above. Operations or functions performed by one device may also be performed by another device. Additionally, an operation described as being performed by one device (such as a mobile device receiving information) may incorporate herein a reciprocating operation by another device (e.g., a base station sending the information).

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

A system may include, but is not limited to, one or more components, devices, and/or networks capable of communicating or otherwise interacting with one another. For example, a system may include a processor communicatively coupled to a memory device storing one or more machine-readable instructions. A system may also, or alternatively, include a computing device (e.g., a mobile device, a computer, etc.) capable of communicating, or otherwise interacting, with another computing device and/or network device (e.g., a router, base station, repeater, network hub, etc.). A system may also, or alternatively, include network components capable of communicating, or otherwise interacting, with one another. A device may include, but is not limited to, a physical object comprising one or more components configured to communicate or otherwise interact with one another. For example, a device may include a processor coupled to a memory device, an antenna, and/or one or more other types of components via a communication interface. A method may include, but is not limited to, one or more operations, functions, processes, and/or other types of state-changing actions, which may be performed by one or more systems, devices, and/or components, or any combination thereof.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE), comprising:
a memory; and
one or more processors configured to, when executing instructions stored in the memory, cause the UE to:
receive, from a base station, a resource allocation that includes a time domain and a frequency domain; and
communicate, to the base station, uplink (UL) information by switching between sub-band full duplex (SBFD) communications and non-SBFD communications within the time domain of the resource allocation.

2. The UE of claim 1, wherein the resource allocation indicates slots or symbols for the SBFD communications and the non-SBFD communications.

3. The UE of claim 1, wherein:
at least one of the SBFD communications includes a sounding reference signals (SRS), and
a reference point for SRS resource element (RE) mapping is subcarrier 0 in common resource block 0, or a lowest subcarrier of a UL sub-band of the SBFD communications.

4. The UE of claim 1, wherein:
at least one of the SBFD communications includes a sounding reference signals (SRS), and
the UE is configured to communicate the SRS using resource elements (REs) within a UL sub-band of an SBFD communication.

5. The UE of claim 1, wherein:
at least one of the SBFD communications includes a sounding reference signals (SRS), and
the UE is configured to communicate the SRS regardless of whether N_{SHIFT} is greater than start or equal to N_{ULSB}^{start}.

6. The UE of claim 1, wherein the UE is configured to receive configuration information and the configuration information comprises:
a first transmission control indicators (TCI) UL-state-ID (TCI-UL-State-ID) corresponding to a sounding reference signals (SRS) via at least one of the SBFD communications, and
a second TCI-UL-State-ID corresponding to the SRS via at least one of the non-SBFD communications.

7. The UE of claim 1, wherein the UE is configured to receive configuration information and the configuration information comprises:
a first TCI is associated with a first set of power control parameters for SRS via at least one of the SBFD communications, and
a second TCI is associated with a second set of power control parameters for SRS via at least one of the non-SBFD communications.

8. The UE of claim 1, wherein:
the resource allocation comprises a type 0 frequency domain resource assignment (FDRA) for a physical uplink shared channel (PUSCH), and
the UE is configured to determine nominal resource block groups (RBGs) for the SBFD communications based on a size of a UL sub-band of the SBFD communications.

9. The UE of claim 1, wherein:
the resource allocation comprises a type 0 frequency domain resource assignment (FDRA) for a physical uplink shared channel (PUSCH), and
the UE is configured to determine nominal resource block groups (RBGs) for the SBFD communications based on a size of a UL bandwidth part (BWP) of the non-SBFD communications.

10. The UE of claim 1, wherein:
the resource allocation comprises a type 1 frequency domain resource assignment (FDRA) for a physical uplink shared channel (PUSCH), and
a start length indicator value (SLIV) for the SBFD communications is based on a size of a UL sub-band of the SBFD communications.

11. The UE of claim 1, wherein:
the resource allocation comprises a type 1 FDRA for a PUSCH, and
a SLIV for the SBFD communications is based on a UL BWP size of the non-SBFD communications.

12. The UE of claim 1, wherein:
the resource allocation comprises a PUSCH with repetitions that spam the SBFD communications and the non-SBFD communications, and
the UE is configured to drop the PUSCH during the SBFD communications when a FDRA of the PUSCH does not fit within a UL sub-band of the SBFD communications.

13. The UE of claim 1, wherein the UE is configured to receive configuration information and the configuration information comprises:
a type 1 configuration grant (CG) for a PUSH (CG-PUSCH) with first parameters for the SBFD communications and second parameters for the non-SBFD communications.

14. The UE of claim 1, wherein:
the UE is configured to receive a first set of downlink (DL) control information (DCI) and a second set of DCI,
the UE is configured to apply the first set of DCI to the SBFD communications or the non-SBFD communications based on which type of communication is first in a time domain of a PUSCH of the resource allocation, and
the UE is configured to apply the first set of DCI to the SBFD communications or the non-SBFD communications based on which type of communication is second in the time domain of the PUSCH of the resource allocation.

15. The UE of claim 1, wherein:
the UE is configured to receive a first set of DCI and at least one delta value,
the UE is configured to generate a second set of DCI by using the at least one delta value to modify the first set of DCI, and
the UE is configured to apply the first set of DCI and the second set of DCI to the SBFD communications and the non-SBFD communications.

16. The UE of claim 1, wherein:
the UE is configured to receive DCI for multi-grant scheduling, the DCI comprising a first modulation and coding scheme (MCS) field for the SBFD communications and a second MCS field for the non-SBFD communications.

17. The UE of claim 1, wherein:
the UE is configured to receive DCI for multi-grant scheduling, the DCI comprising a first FDRA field for the SBFD communications and a second FDRA field for the non-SBFD communications.

18. The UE of claim 1, wherein the UE is configured to receive DCI for multi-grant scheduling, the DCI comprising an FDRA field with a size based on a UL sub-band of the SBFD communications or a BWP of the non-SBFD communications.

19. Baseband circuitry, comprising:
a memory; and
one or more processors configured to, when executing instructions stored in the memory, cause the baseband circuitry to:
process a resource allocation that includes a time domain and a frequency domain; and
generate uplink (UL) information configured for switching between sub-band full duplex (SBFD) communications and non-SBFD communications within the time domain of the resource allocation.

20. A base station, comprising:
a memory; and
one or more processors configured to, when executing instructions stored in the memory, cause the base station to:
communicate, to a user equipment (UE), a resource allocation that includes a time domain and a frequency domain; and
receive, from the UE, uplink (UL) information by switching between sub-band full duplex (SBFD) communications and non-SBFD communications within the time domain of the resource allocation.
